(19) United States
(12) Patent Application Publication
(10) Pub. No.: US 2016/0318642 A1
(43) Pub. Date: Nov. 3, 2016

(54) AUTOMATIC INSTALLATION FOR THE AUTOMATIC OPENING OF CRATES FOR ORTHI-CULTURAL AND OTHER PRODUCTS

(71) Applicant: UNITEC S.P.A., Lugo (IT)

(72) Inventor: Luca BENEDETTI, Savarna (IT)

(73) Assignee: UNITEC S.P.A., Lugo (IT)

(21) Appl. No.: 15/101,213

(22) PCT Filed: Nov. 25, 2014
(86) PCT No.: PCT/IB2014/066325

§ 371 Date: Jun. 2, 2016

(30) Foreign Application Priority Data
Jan. 24, 2014 (IT) PN2014A000004

(51) Int. Cl. B65B 43/26; B65G 59/00; B65G 57/10

(52) U.S. Cl. CPC B65B 43/265; B65G 57/10; B65G 59/00; B65G 2201/025

(57) ABSTRACT

Apparatus to move automatically and in a continuous sequence a plurality of crates in succession, preferably of orthi-cultural products, and vertically laid one on the other so as to form a related stack, able of carrying out the transfer of a first stack to a first loading station, of opening the related crates and of forming a first stack of opened crates; it comprises a first loading conveyor provided with a first loading end, first support means adjacent to said first end and supporting a pallet on which a stack of closed crates is deposed, a first pushing means, placed externally with respect to the vertical projection of said first support means and at a level slightly higher than the level of said first conveyor, in order to transfer, with a translatory and orderly motion, one or more stacks from the pallet to the first loading end.

The apparatus is basically able of dealing with the successive stacks of opened crates, produced and available, so as to load, onto a different succession of pallets, a plurality of stacks placed side by side and on the same pallet.

The present invention relates to a perfected installation to automatically move stacks of closed crates and stacks of opened crates produced in an apparatus apt to open the crates normally used to contain orthi-cultural products; in fact, it has to be reminded that after being used and emptied, said crates are closed again reclining inwards the relative vertical walls.

The object of this operation is that of considerably reducing the overall bulk of said crates, as after being used, they have to be rearranged so as to be sent again to the harvesting and filling centres.

Such need has been clearly explained in patent WO 2012/156375 of the same applicant, and, for brevity, which it can be referred to and therefore it will not be discussed any further.

Anyway, as these crates can have different sizes, both for the type of content and mainly for the different destination and downstream commercial requirement, suitable apparatuses apt at opening crates having different sizes have been devised and disclosed: therefore, they offer a high usage flexibility, which considerably increases their productivity and hence their economic value.

Such apparatuses are described in the Italian patent application N. PN2013A000053, which, for brevity, it can be referred to.

By using such apparatuses industrially it has been seen that their increase in productivity, though high, was limited by the fact that the operations,
of loading into said apparatuses stacks of closed crates coming from the harvest centres of the orthi-cultural products,
and after opening them, the symmetrical unloading and removal of the stacks of crates to be dispatched to the same centres,
   were carried out by means of traditional means and methods, which then reduced the overall efficiency of the whole process of opening the crates and more generally it reduced the efficiency of the related logistics that is of both workers and means using said apparatuses.

It would therefore be desirable, and it is the main object of the present invention, to realize an installation apt at carrying out, using widely known and tested techniques,
a method of loading a succession of single stacks of closed crates to and into an automatic installation for opening said crates,
and, after opening said crates, of gathering them again in a succession of stacks of opened crates and unloading said new stacks onto the respective pallets,
   wherein said operations:
of unloading said stacks of closed crates from the receiving pallet,
of introducing said stacks in the apparatus for opening crates, of extracting the stacks of opened crates,
and of the final orderly loading said crates onto suitable outgoing pallets, are carried out with completely automatic, both executive and command and control methods and means.

Such object is achieved by means of an installation realized according to the appended claims.

Characteristics and advantages of the invention will become apparent from the following description, for exemplification only but not limited to, with reference to the appended figures wherein:

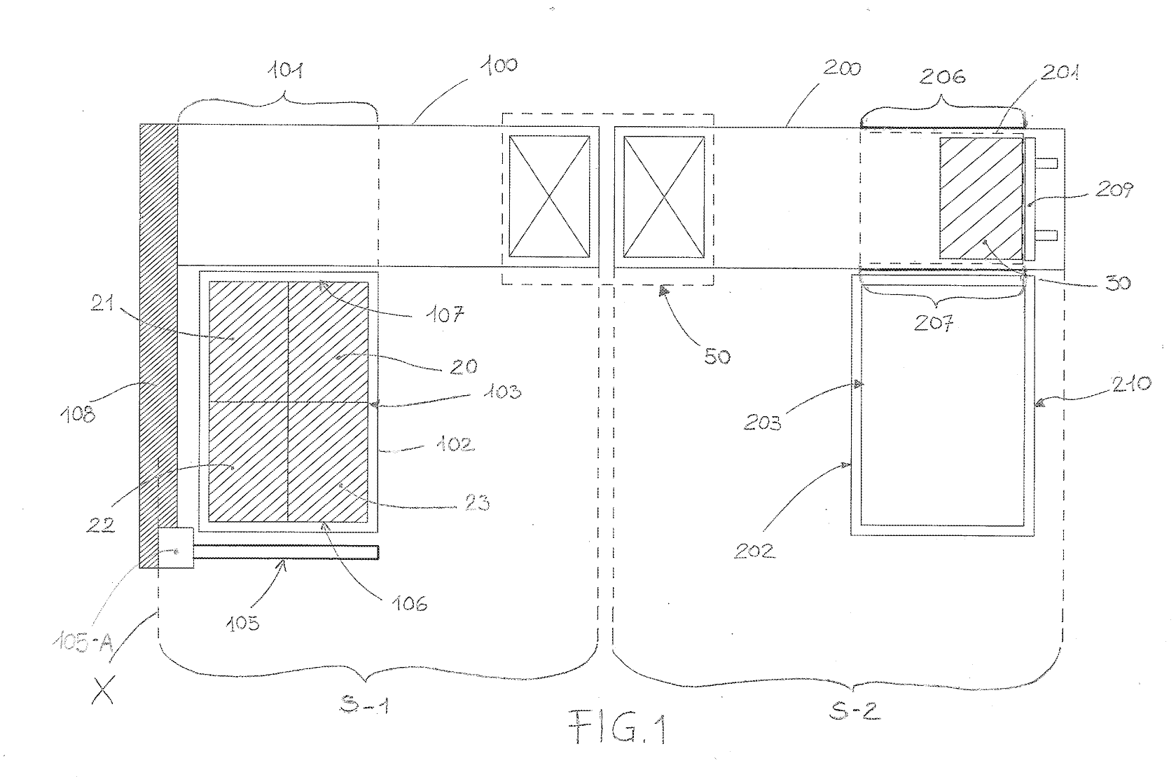

FIGS. 1, 2, 3, 4, 5 and 6 show a schematic top plan view of a plurality of successive steps of the operating organs of an installation according to the invention,

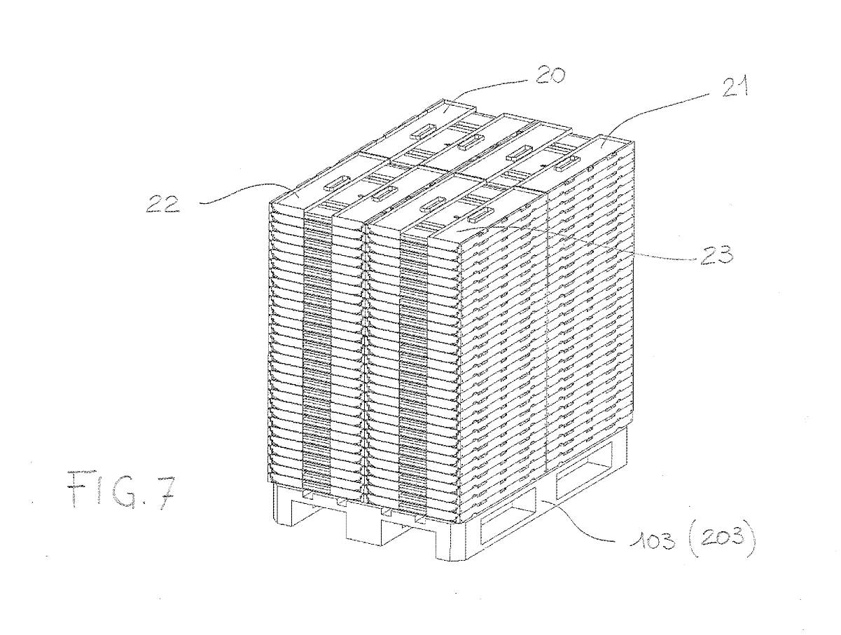

FIG. 7 shows a schematic perspective view of a pallet containing a plurality of stacks of closed crates,

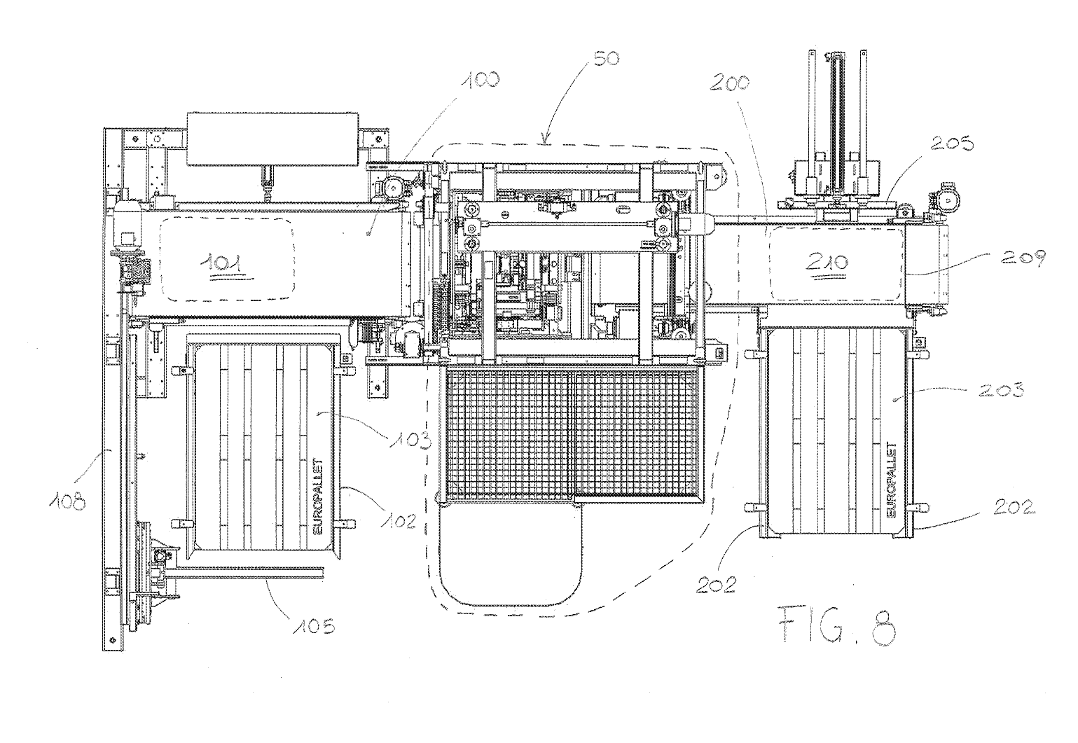

FIG. 8 shows a top plan view describing an example of a real construction of the installation of FIG. 1,

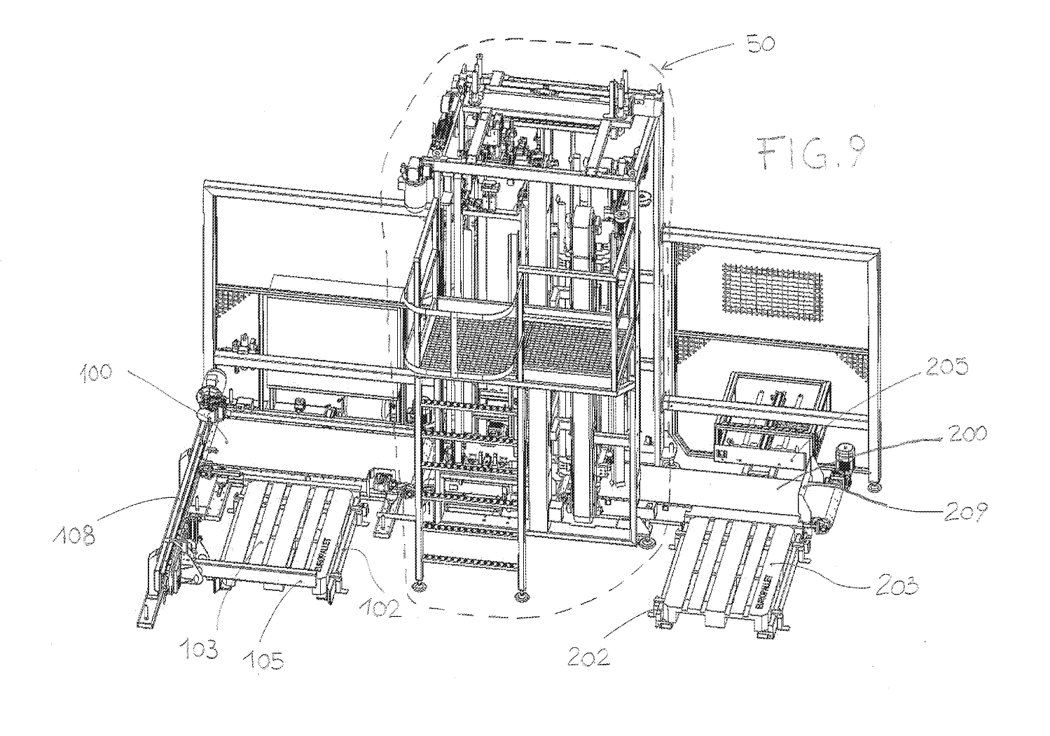

FIG. 9 shows a diagonal perspective view of a real example of the installation of FIG. 8.

As an apparatus according to the invention is constructively very complex and articulated for the amount of components and devices, and generally of the support, connecting, etc. means to assemble, in the following description it will be referred to very schematic and symbolic drawings and/or figures completely different, in their representation, from the corresponding means and devices used in the real apparatus of the invention; the purpose of the choice of this type of representation is only that of facilitating the reader in understanding the invention by focusing his attention only on the elements being described.

Moreover, in case it is desired to verify the congruity of said representations with a real apparatus according to the invention, the appended FIGS. 8 and 9 give the skilled in the field the necessary and sufficient information to recognize, in those figures, the main assemblies or functional groups which are shown in detail in the previous and schematic FIGS. 1 to 7.

In order to make the description simple, as described in the aforementioned WO 2012/15, the installation of the present invention is generally composed of, from the functional point of view, two distinct working stations, and that is, a first station S-1 wherein the succession of stacks of closed crates arrives and which is provided with organs and mechanisms to open the single crates one at a time, and to move them to a second station S-2, where the same succession of crates, but this time opened, are restacked and definitively moved outside the whole installation.

Therefore, for preciseness, it is clarified that the part of the apparatus not explicitly described here and concerning the means and methods to open the closed crates in the apparatus and to make them available as a succession of stacks of opened crates, is to be understood as described in said WO 2012/156375.

Then, synthetically, the apparatus to open the crates carries out the following operations:
a) moving one or more stacks of closed crates to a first receiving and loading station (S-1),
b) opening and blocking the opposed walls of the crate placed on the top of a first stack,
c) transferring said opened crate, in a horizontal direction, into a position overlying a stack of previously opened crates arranged on a second working station (S-2) able of generating a succession of stacks (16) of opened crates,
d) and lowering said opened crate to the support level on the respective bottom plane.

A first general description is herewith given; later it will be given a detailed description of the installation and of how it works.

The installation of the invention is mainly based on operating means and methods which load onto an incoming conveyor belt a plurality of stacks of crates in a sequence and in multiple amount, that is more than one stack at a time are loaded onto the infeed conveyor.

These stacks are picked from a pallet placed beside said infeed conveyor, on that pallet there are deposed two or more rows of stacks of crates arranged into rows parallel one to the other, and parallel to the conveyor as well, that is, they are parallel to the direction of the infeed conveyor motion.

Each row comprises two or even more stacks placed side by side in an orderly way and basically adjacent, as it will be apparent from the figures.

For example, in practical terms, on the pallet there is a first row of stacks adjacent to the conveyor, and on the same pallet, behind the first row, there is a second row of stacks.

In order to load the stacks of the first row on the infeed conveyor, there is placed a pushing means at the back of, that is behind the second row of stacks.

By operating said pushing means against said second row, the related stacks come into contact with the stacks of the first row and by continuing the stroke of the pushing means, they push them towards and then onto said infeed conveyor.

After it has made the single stacks go towards the apparatus for opening the crates, the space before said pallet is of course emptied from the previous stacks; at this point a further stroke of said pushing means towards the conveyor makes the second row of stacks move as well and causes it to get onto the same infeed conveyor.

In this way, on the same conveyor there are loaded, in the given example, all the four stacks placed on the pallet, but their loading is carried out two stacks at a time; besides, it is employed only one pushing means placed at the back of the stacks farther from the infeed conveyor, and the pushing action on the stacks of the first row is carried out giving the stacks of the second row, they too pushed by the pushing means, the task of pushing forward, that is onto the conveyor, the stacks of the first row.

As regards picking the stacks of the opened crates, it is used a suitable outfeed conveyor; this one is placed downstream the apparatus for opening the crates, and to unload the related stacks it is basically used the same criterion and the same general operating mechanism, anyway keeping in mind that here the operations have to be reversed.

Therefore only one pushing means pushes two or more stacks of crates on the conveyor, out of the conveyor and on the adjacent pallet.

Subsequently, when other stacks of crates are on the outfeed conveyor but before the same pallet, the same pushing means also pushes these second stacks onto the pallet; as this one is already partially loaded with the previous stacks, the last stacks automatically push forward the previous stacks, so that the space on the pallet, previously taken up by the first stacks, is finally taken up by the last loaded stacks.

Herewith is the detailed description.

With reference to the figures, said first receiving and loading station S-1 comprises:
a first loading conveyor 100, provided on its part opposed to the part directly feeding the apparatus for opening the crates 50, with a first loading end 101 of said stacks of closed crates,
a support means or frame 102 adjacent o said first end 101;
a first pushing means 105.

Said support means 102 basically consists of a frame whereon single bases or pallets 103, as they will be referred to further on, can be deposed, which have previously been loaded with one or more stacks of closed crates.

Preferably such pallets are loaded with four distinct stacks 20, 21 22, 23 having a regular “straight grid” geometry, as schematically shown in FIG. 7.

Said frame 102 is placed so that one of its sides 107 is adjacent and at about the same level as that of the loading end 101 of said first conveyor, so that it is possible and easy to simply push the stacks of dosed crates, which are on the related pallet 103, out of this pallet and onto said loading end 101 of the conveyor 100.

In order to push said crates, it is provided and employed pushing means, preferably made up of a simple bar 105, basically placed horizontally and parallel to the first conveyor 100, and positioned near the side 106 of said frame 102, on the opposed side of said side 107.

This bar 105, suitably positioned at a level slightly higher than the level of the upper surface of the pallet 103, is made able, with means and methods known per se, to be moved towards the conveyor 100, so that it can intercept the stacks of closed crates lying on the pallet 103 and push them neatly towards and onto said loading end 101.

Therefore, said bar is preferably oriented parallel to the direction of said first conveyor 100, and provided with displacement means, preferably a properly motorized guide 108 whereon an end 105-A of such bar 105 is caused to slide, in order to move it towards said first conveyor 100 with a translatory rectilinear motion.

Said bar 105 can also be moved into rotation according to a rotation axis “X”:
orthogonal to the first conveyor 100,
basically horizontal,
and passing through the same end 105-A on which said motorized guide 108 is engaged.

The operation of such receiving and loading station S-1 is herewith described.

With reference to FIG. 1, the pallet 103 is already deposed on said frame 102, and said bar 105 is placed behind the same pallet, that is, the farthest from the conveyor 100, and besides it is lowered, and hence behind the 4 stacks of closed crates 20, 21, 22, 23 as well.

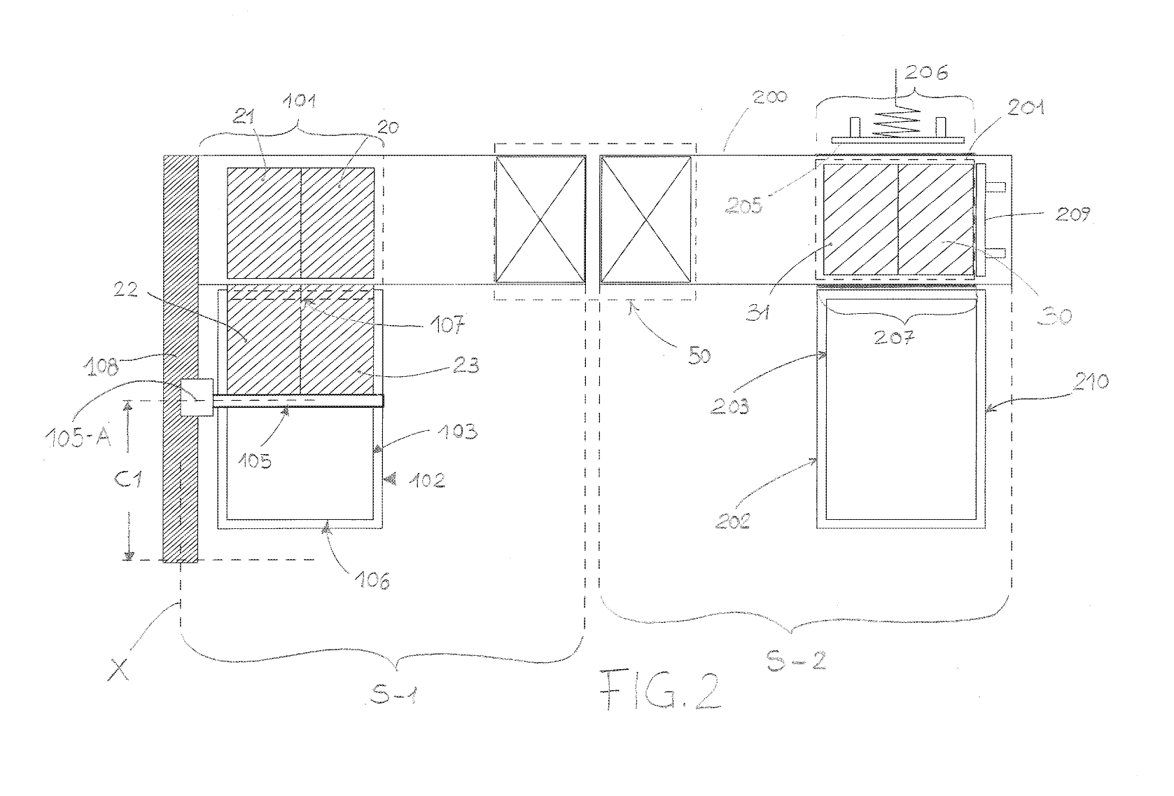

With reference to FIG. 2, said bar 105 is moved forward, that is towards the conveyor 100 for a first predefined stroke “C1”.

The extent of such stroke has to be so as to push the two stacks 20 and 21, nearest to the conveyor 100, out of the pallet 103 to get onto said conveyor 100, where they keep their related position, as the motion impressed by the bar 105 is a translatory rectilinear one.

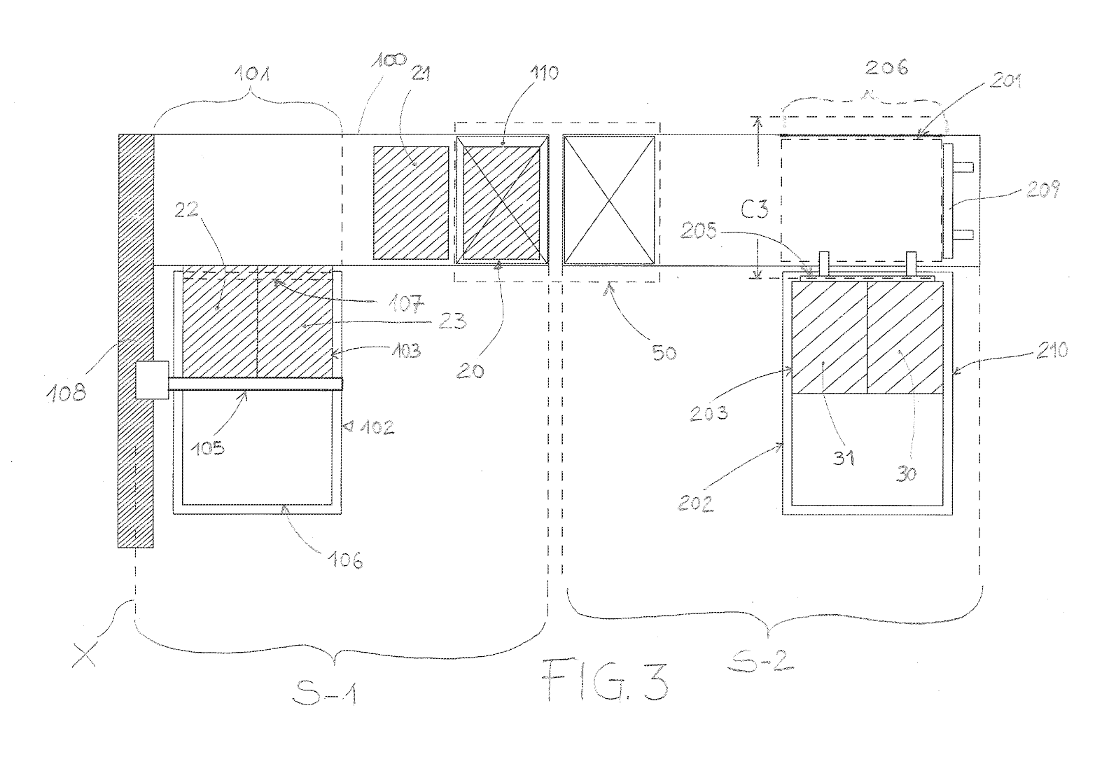

With reference to FIG. 3, the conveyor 100 is activated causing it to move towards its end 110 opposed to said loading end 101 until the first stack is placed exactly in the position in which the apparatus 50 for opening the crates can engage said stack 20 and start the opening procedure, known per se.

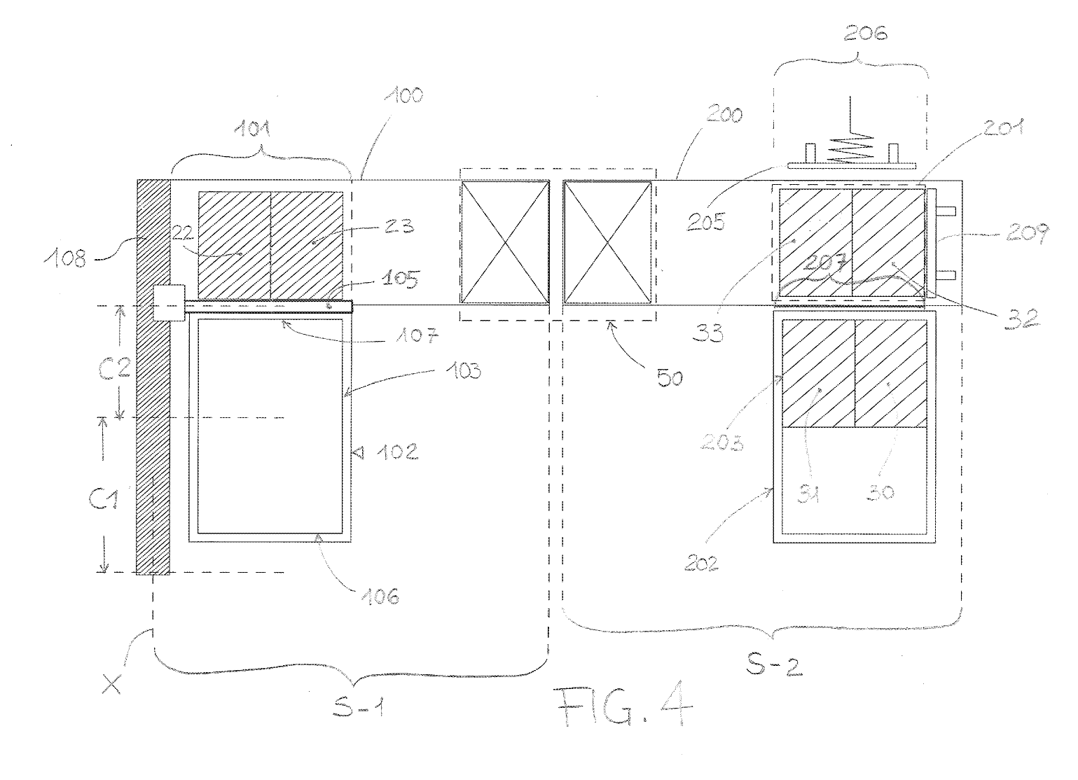

With reference to FIG. 4, said bar 105 is again moved forward, that is towards the conveyor 100 for a predefined second stroke “C2”.

The extent of the stroke has to be such as to push also the two remaining stacks 22 and 23, at first farthest from the conveyor 100, out of the pallet 103 in order to get onto said conveyor 100, where they keep their related position.

At this point it has to be observed that:
said second stroke “C2” can occur only when the motion of the conveyor 100 is of such extent to have “cleared” the space on said loading end 101 so as to allow the loading of the two last stacks 22, 23 onto it and
in any case, the motion of the conveyor has to be slaved and controlled by the apparatus for opening the crates 50, as said conveyor has to feed said apparatus with a new stack of closed crates present on the conveyor 100 only after the previous stack has been completely bottomed.

Anyway, it is apparent that such functional and constructive constraints are completely understandable by the skilled in the field, as of course, it is to be avoided any risk of interference between the stacks on the conveyor 100, either caused by a too early loading of new stacks from the pallet 103, or caused by a too early progress of the conveyor when the previous stack is still on the opening apparatus 50.

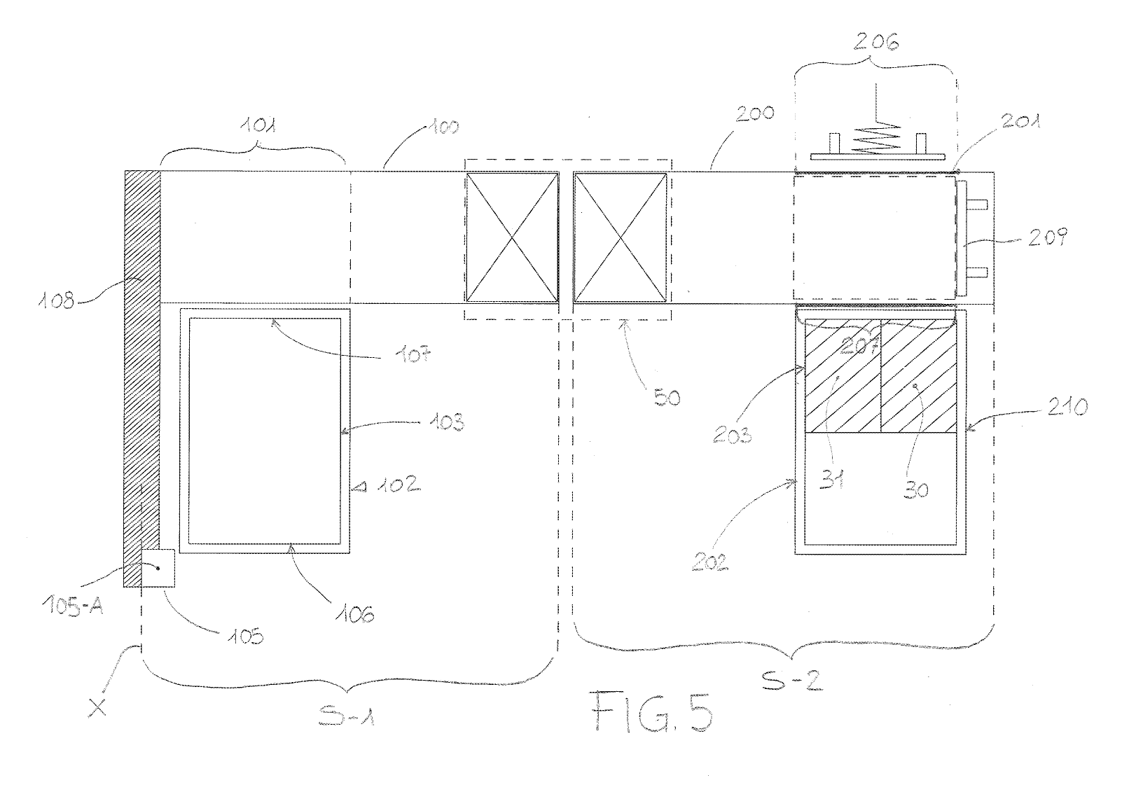

With reference to FIG. 5, said bar 105 goes back to its starting position along the motorized guide 108 but with a different arrangement, that is it does not remain horizontal but it is rotated around the axis “X” so as to clear the passage on said frame 102 and therefore fundamentally allow both the precautionary removal of the just emptied, still therein pallet, and to move a successive pallet loaded with stacks of closed crates onto this frame.

This series of operations ends when the bar 105 goes back to its starting position and arrangement, that is horizontal, as shown in FIG. 1.

Obviously these “return” operations are completely identical, but of course reversed with respect to the previous “loading” operations and therefore the respective figures are omitted for simplicity's sake.

With reference to the figures, said second unloading station S-2 comprises:
a second unloading conveyor 200 provided, on its part opposed to the part fed by the apparatus for opening the crates 50, with an unloading end 201 of said stacks of opened crates,
a support structure 202 adjacent to said end 201,
a second pushing means 205.

Said support structure 202 basically consists of a frame whereon there can be deposed single bases or pallets 203 completely similar or identical to the previous ones.

Preferably such pallets are loaded with four distinct stacks 30, 31, 32, 33 having a regular “straight grid” geometry, completely identical to that on the pallets with the stacks of closed crates.

On said second conveyor 200, and separated from this one, it is placed a stopping means 209 fixed to the installation structure, and able of being a permanent obstacle for the stacks of opened crates transported by the conveyor 200; of primary importance is the fact that said stopping means 209 is positioned so that the successive stacks of opened crates are stopped against said stopping means 209 exactly before said frame 202, so that a lateral motion of these stacks makes them move, in a precise way, from the conveyor 200 to the pallet on said frame 201 with methods which will be later described,

Said frame 202 is placed so that one of its sides 207 is adjacent to said frame 202 and at about the same level as that of said unloading end 201, defined by the position of said stopping means 209 of said second conveyor, in this way, it is possible and easy to simply push the stacks of opened crates, which are on the related conveyor 200, out of it and onto the pallet 203 which is on said frame 202.

In order to push said crates, it is made and employed pushing means 205, basically placed horizontally and parallel to the second conveyor 200, and positioned near its side 206 on the opposed part of said side 207 of the same conveyor 200.

This pushing means 205, suitably positioned at a level slightly higher than that of the upper surface of the pallet 203, is made able, with means and methods known per se, to be moved towards the conveyor 200, so that it can intercept the stacks of opened crates lying on the conveyor 200 and pushes them neatly towards and onto the related adjacent pallet 203 placed on the related frame 202.

Therefore said pushing means 205 is preferably oriented parallel to the direction of said second conveyor 200, and provided with displacement means, known per se, in order to make it move with a translatory rectilinear motion towards said pallet 203.

As for said unloading station S-2, its operation is herewith described.

With reference to FIG. 1, the stack 30 is already deposed on the conveyor 200 that, moving forward, has made said stack 30 get against said stopping means 209, against which it has naturally stopped.

With reference to FIG. 2, a new stack of opened crates 31 has been deposed on the second conveyor 200 whose forward motion, suitably controlled, has carried said second stack 31 against the previous crate 30, already stopped by the stopping means 209; therefore said two crates 30 and 31 come to be together on one of their sides and remain durably in the position defined by the stopping means 209, even if the related conveyor should continue to move.

With reference to FIG. 3, said pushing means 205 is moved forward, that is towards the related pallet 203 for a third predefined stroke “C3”.

The extent of stroke has to be such as to push the two stationary stacks 30 and 31 out of the conveyor 200, towards the related pallet and finally onto that, where they keep their related position as the motion given by the pushing means 205 is a translatory rectilinear one.

With reference to FIG. 5, the pushing means 205 is brought back to the starting position to enable the conveyor 200 to move two other stacks of opened crates 32 and 33 against said stopping means 209, according to methods completely similar to those described in the previous points 6) and 7).

With reference to FIG. 4 the conveyor 200 is activated so that the successive stacks 32 and 33, placed thereon in a programmed succession, subsequently stop as described above, and that is, the first stack 32 is blocked by the stopping means 209, and subsequently the following stack 33 is blocked against the stack 32 preceding it but already stopped, as said stack 32 acts as a stopping means with respect to the second stack 33; basically, regarding the position of the stacks on the conveyor 200, it occurs the same situation as in the previously described FIG. 2, but with different stacks as they are successive.

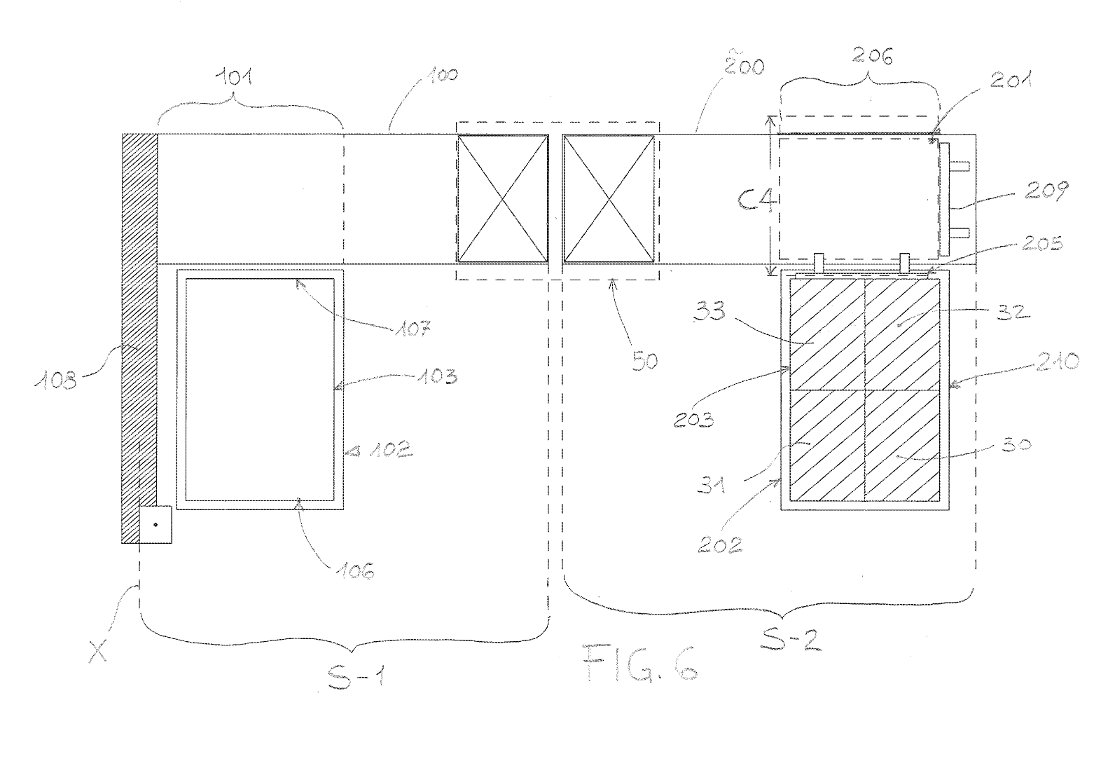

With reference to FIG. 6, said pushing means 205 is again moved forward, that is, towards the pallet 203 for a predefined fourth stroke “C4”.

The extent of stroke has to be such as to make it possible to push sideways the two stacks 32 and 33 enough so that these go into contact with the stacks 30 and 31 already loaded onto the first part of the pallet 203, and then they are pushed enough to move them on new farther positions on the same pallet 203 where they keep their related position.

It will be evident that, in this way, the space on the conveyor 200 is completely emptied in order to allow the arrival of two other stacks of opened crates, which of course are accumulated according to what already described.

At this point it must be observed that:
said operation of the pushing means 205 has to be coordinated with the motion of the conveyor 200, as it must not occur that said conveyor might transfers further stacks in the area of the pushing means 205 when said pushing means 205 is still present in the space on the same conveyor and,
said fourth stroke “C4” can be carried out only when the motion of the conveyor 200 is of such extent so as to have “loaded” the space on said loading end 201 with two successive stacks of opened crates, so as to make it possible the proper loading of two stacks at a time on the related pallet 203,
anyway, also in this case, the motion of the conveyor has to be slaved and controlled by the apparatus for opening the crates 50, as said conveyor 200 has to remove a new stack of opened crates from said apparatus only after the previous stack has been, in its turn, removed.

Basically, the motion of the outfeed conveyor 200 has to be slaved both to the production of opened crates by the apparatus 50, and to the state of the stacks before the related pushing means 205.

Anyway, it is clear that such constructive and functional constraints are completely clear to the skilled in the field, as, of course, it must be avoided any risk of interference between the stacks on the conveyor 200 that can be caused:
by a too delayed loading of new stacks on the pallet 203,
or provoked by an early progress of the conveyor 200 when the previous stacks have not yet been loaded on the pallet 203.

After having loaded the two distinct stacks 30, 31 and 32, 33, said pushing means 205 returns to its starting position in order to start a new working cycle completely identical to the one just described.

This series of operations is ended with the simple return of the pushing means to the starting position, that is external to the outfeed conveyor 200, as shown in FIG. 2.

The related representation of such operation of return and reinstatement of the starting condition, which can be seen in FIG. 2, is omitted as it is in itself obvious.

Of course these “return” operations are completely identical, but of course reversed with respect to the previous operations.

The skilled in the field will have noticed that the present teaching can be employed, with due installation and working modifications, also for loading and unloading pallets where there are placed a number of stacks for each front row in a number different from what exemplified above and in the figures, and typically more than two; and of course the same consideration applies to what is related to the unloading operations from the outfeed conveyor which transports the opened crates.

According to a perfected embodiment of the invention, all said manoeuvring organs, various kinds of actuators, first conveyor 100, first pushing means, second conveyor 200, second pushing means etc. are all connected to a control and command unit, not shown, wherein there are stored all the commands to activate, with a pre-determined sequence and, above all, of a pre-defined extent, all of said working organs, devices, means, etc. according to the complete dimensions of each type of crates to be opened.

It is to be noted that suitable sensor means, not shown, are provided which are placed on the two conveyors 100 and 200 apt to detect the presence or absence of stacks in precise and pre-determined positions, so as to allow an orderly operation of the installation according to the described method; of course said sensors, too, are connected to the control and command unit.

In this way, it becomes possible and immediate to introduce a single instruction into said command and control unit so that all the organs, devices, actuators, sensors, etc. are positioned or actuated automatically, sequentially and synchronized by means of the respective corresponding parameters stored into said control and command unit.

Not only, but the same unit is able to store, in an orderly and aggregate way, the parameters corresponding to a plurality of types of crates showing different sizes, so that, as the skilled in the field will already have understood, it is possible and immediate to introduce into said command and control means a simple coded instruction representative of a specific crate type and/or pallet, and automatically obtain that said command and control means processes and analyzes said coded instruction into a plurality and orderly succession of commands and transmits to said organs, devices, actuators, etc. suitable signals able of determining in them the correct positioning and operation corresponding to the type of selected stack and of pallet.

Anyway, the realization of such command and control unit and the programming of the related data storage and instructions are activities completely feasible by the skilled in the field, therefore they will not described any further.

1. Installation to automatically carry out the loading and unloading operations of an apparatus able of opening the closed side walls of a plurality of crates, preferably of orthi-cultural products, provided with a bottom plane and with two couples of opposed walls, each of them being hinged on said bottom plane and are placed in an ordered and identical way, and vertically laid one on the other so as to form one or more stacks, able of carrying out the following operations:
a) moving one or more stacks of closed crates in a first of receiving and loading station,
b) opening and blocking the opposed walls of the crate placed on the top of a first stack,
c) transferring an opened crate in an horizontal direction into a position overlying a stack of previously opened crates arranged on a second unloading station able of generating a succession of stacks of opened crates,
d) and lowering said opened crate to the support level on the respective bottom plane, wherein said first receiving and loading station comprises:
a first loading conveyor provided with a first loading end of said stacks of closed crates,
first support means adjacent to said first end able of engaging a pallet on which one or more stacks of closed crates can be deposed,
first handling means able of transferring by a translatory motion said stacks of closed crates from said pallet to said first loading end.

2. Installation according to claim 1, wherein said first handling means comprise a first pushing means:
placed in correspondence of the side of said first support means opposed to the side adjacent to said first conveyor,
placed at a level slightly higher of the level of said first conveyor.

3. Installation according to claim 2, wherein said first pushing means comprises a horizontally stretching bar oriented preferably parallel to the direction of said first conveyor, and provided with displacement means, preferably a properly motorized guide, an end of which is made to slide on, said bar being able to be moved towards said first conveyor and removed from it with a translatory and substantially orthogonal motion with respect to said first conveyor.

4. Installation according to claim 3, wherein said bar is provided with means able of making it to move into rotation according to a rotation axis (x) basically horizontal and orthogonal to the bar itself, and passing on the same end on which said motorized guide is engaged.

5. Installation according to claim 1, wherein said second unloading station comprises:
a second unloading conveyor provided with a second unloading end of said succession of stacks of open crates,
second supporting means adjacent to said second end, and able of engaging a pallet on which a plurality of open crates may be laid down,
second handling means able of transferring with a translatory motion said stacks of opened crates from said second unloading end to said pallet.

6. Installation according to claim 5, wherein said second handling means comprise a second pushing means arranged substantially horizontal and parallel to said second conveyor and arranged next to the side of it which is placed opposed to the side of it adjacent to said second supporting means.

7. Installation according to claim 6, wherein it comprises a stopping means placed on the position of said second unloading conveyor:
substantially orthogonal to said second conveyor,
and preferably corresponding to the position of said second unloading end aligned to an end portion of said second supporting means.

8. Installation according to claim 1, wherein it comprises command and control means, and respective linking means, able of implementing successively, also in a non-continuous way, the following operations:
activating said bar so as to place it horizontally,
moving said bar towards said first conveyor for a first pre-defined stroke,
making said first conveyor to move forward for a pre-determined length,
moving again said bar towards said first conveyor for a second pre-determined stroke.

9. Installation according to claim 1, wherein it comprises command and control means able of:
making said second conveyor to move forward until one or more stacks of open crates accumulate successively against a first stack touching said stopping means,
making said second pushing means to work for a third pre-determined stroke, and return back in the starting position,
making said second conveyor to move forward until a successive accumulation of a predetermined number of crates against a first stack in contact against said stopping means,
moving again forward said second pushing means for a respective fourth pre-determined stroke.

10. Installation according to claim 1, wherein it comprises command and control means able of:
storing the parameters corresponding to the horizontal sizes of a respective plurality of types of crates showing different sizes,
introducing into said command and control means a coded instruction representative of a specific crate type, and automatically obtaining that said command and control means process and transmit to the working devices, organs, devices, actuators charged to move said stacks of closed and open crates on said two respective conveyors and on said first and second pushing means suitable signals able of determining either:
the opening and closing command of said bar,
the lengths of said strokes of the respective bar and of the respective second pushing means,
the length of the moving lengths forward of said first and second conveyor,
the working sequence of said bar of said first conveyor, of said second conveyor, and of said second pushing means.

11. Installation according to claim 2, wherein said second unloading station comprises:
a second unloading conveyor provided with a second unloading end of said succession of stacks of open crates,
second supporting means adjacent to said second end, and able of engaging a pallet on which a plurality of open crates may be laid down,
second handling means able of transferring with a translatory motion said stacks of opened crates from said second unloading end to said pallet.

12. Installation according to claim 3, wherein said second unloading station comprises:
a second unloading conveyor provided with a second unloading end of said succession of stacks of open crates,
second supporting means adjacent to said second end, and able of engaging a pallet on which a plurality of open crates may be laid down,
second handling means able of transferring with a translatory motion said stacks of opened crates from said second unloading end to said pallet.

13. Installation according to claim 4, wherein said second unloading station comprises:
a second unloading conveyor provided with a second unloading end of said succession of stacks of open crates,
second supporting means adjacent to said second end, and able of engaging a pallet on which a plurality of open crates may be laid down,
second handling means able of transferring with a translatory motion said stacks of opened crates from said second unloading end to said pallet.

14. Installation according to claim 2, wherein it comprises command and control means, and respective linking means, able of implementing successively, also in a non-continuous way, the following operations:
activating said bar so as to place it horizontally,
moving said bar towards said firs conveyor for a first pre-defined stroke,
making said first conveyor to move forward for a pre-determined length,
moving again said bar towards said first conveyor for a second pre-determined stroke.

15. Installation according to claim 3, wherein it comprises command and control means, and respective linking means, able of implementing successively, also in a non-continuous way, the following operations:
activating said bar so as to place it horizontally,
moving said bar towards said firs conveyor for a first pre-defined stroke,
making said first conveyor to move forward for a pre-determined length,
moving again said bar towards said first conveyor for a second pre-determined stroke.

16. Installation according to claim 4, wherein it comprises command and control means, and respective linking means, able of implementing successively, also in a non-continuous way, the following operations:
activating said bar so as to place it horizontally,
moving said bar towards said firs conveyor for a first pre-defined stroke,
making said first conveyor to move forward for a pre-determined length,
moving again said bar towards said first conveyor for a second pre-determined stroke.

17. Installation according to claim 5, wherein it comprises command and control means, and respective linking means, able of implementing successively, also in a non-continuous way, the following operations:
activating said bar so as to place it horizontally,
moving said bar towards said firs conveyor for a first pre-defined stroke,
making said first conveyor to move forward for a pre-determined length,
moving again said bar towards said first conveyor for a second pre-determined stroke.

18. Installation according to claim 6, wherein it comprises command and control means, and respective linking means, able of implementing successively, also in a non-continuous way, the following operations:
activating said bar so as to place it horizontally,
moving said bar towards said firs conveyor for a first pre-defined stroke,
making said first conveyor to move forward for a pre-determined length,
moving again said bar towards said first conveyor for a second pre-determined stroke.

19. Installation according to claim 7, wherein it comprises command and control means, and respective linking means, able of implementing successively, also in a non-continuous way, the following operations:
activating said bar so as to place it horizontally,
moving said bar towards said firs conveyor for a first pre-defined stroke,
making said first conveyor to move forward for a pre-determined length,
moving again said bar towards said first conveyor for a second pre-determined stroke.

20. Installation according to claim 2, wherein it comprises command and control means able of:
making said second conveyor to move forward until one or more stacks of open crates accumulate successively against a first stack touching said stopping means,
making said second pushing means to work for a third pre-determined stroke, and return back in the starting position,
making said second conveyor to move forward until a successive accumulation of a predetermined number of crates against a first stack in contact against said stopping means,
moving again forward said second pushing means for a respective fourth pre-determined stroke.
